(19) United States
(12) Patent Application Publication
(10) Pub. No.: US 2002/0110711 A1
(43) Pub. Date: Aug. 15, 2002

(54) Method and device for starting a reacator in a gas-generating system

(76) Inventors: Stefan Boneberg, Beuren (DE); Fabian Doling, Neuhausen (DE); Uwe Griesmeier, Markdorf (DE)

Correspondence Address: CROWELL & MORING, L.L.P., P.O. Box 14300, Washington, DC, 20044-4300, US

(21) Appl. No.: 09/985,647

(22) Filed: Nov. 5, 2001

(30) Foreign Application Priority Data
Nov. 4, 2000 (DE) 100 54 840.7

(51) Int. Cl. H01M 8/04; H01M 8/06

(52) U.S. Cl. 429/17; 429/20

(57) ABSTRACT

A method serves for starting a reactor, particularly a reformer, in a gas-generating system of a fuel cell installation at a temperature, which is far below the operating temperature of the gas generating system. A hydrocarbon is reacted for generating thermal energy for heating the reactor. At least a portion of the waste gases of the reacted hydrocarbon flows into the reactor. As the reactor temperature increases, an increasing flow of at least one educt, which is to be reacted in the reactor, is introduced and evaporated at least partly in the at least one portion of the waste gases, which flows into the reactor.

The invention relates to a method for starting a reactor in a gas-generating system of a fuel cell installation of the type, defined in greater detail in the introductory portion of claim 1.

In addition, the invention relates to an apparatus for starting a reactor in a gas-generating system of a fuel cell installation of the type defined in greater detail in the introductory portion of claim 10.

DE 33 45 958 A1 discloses a rapidly starting methanol reactor system, for which a catalytic crack reactor is heated indirectly as well as directly during the starting up process, in order to obtain a rapidly starting system. For this purpose, the fuel, such as methanol, which can be reformed, is first combusted with air in a burner during the starting up process. The waste gases of the combustion are then passed through a combustion chamber, which is in a heat-exchanging relationship with the catalytic cracking reactor, in order to transfer the heat content of the waste gases of combustion to the reactor and to increase the temperature of the catalyst. After that, the waste gases, resulting from the combustion, flow directly through the catalytic bed in order to heat the catalytically active regions directly and bring them particularly rapidly to the required temperature. At the same time, the maximum temperature of the gas stream is controlled by injecting water or quenching with water in such a manner, that damaging the catalyst by overheating is avoided.

U.S. Pat. No. 4,820,594 discloses a method for starting a gas-generating system in a fuel cell installation. By means of the fuel used in the installation, the thermal energy, required for the gas-generating system in the starting phase of the latter, is obtained by a direct combustion of this fuel in the region of at least individual components of the gas-generating system. For this purpose, the fuel, which is reformed by the gas-generating system in the further operation of the installation into the hydrogen-containing gas for the fuel cell, is used for the combustion for the rapid heating of the gas-generating system.

The heating of the reactor or reformer of the above-described state of the art before it is started up results in disadvantages owing to the fact, during the introduction of the educts into the evaporator, there is a sudden evaporation of the educts at least in partial regions. This leads to not inconsiderable compressive stresses in the reformer, as well as to very high material stresses because of the steep temperature gradients in individual parts of the reformer.

It is regarded to be a further disadvantage that, due to the sudden evaporation in places and the therewith associated strong cooling of the reformer, a very poor and inhomogeneous distribution of the temperature and, with that, also a correspondingly poor distribution of the educts in the reformer occur in individual regions. There is therefore a deterioration in the reaction of the educts in the reformer, especially if it is a catalytic reaction.

It is therefore an object of the invention to provide a method for starting a reactor in a gas-generating system which, in the case of a cold start, is very rapidly in a position to heat the reactor and, with a very uniform distribution and an at least partially very uniform evaporation of the educts, which are to be reacted in the reactor, makes it possible to start the gas-generating equipment very rapidly.

Pursuant to the invention, this objective is accomplished by the method with the distinguishing features named in the characterizing portion of claim 1.

In addition, the objective is accomplished pursuant to the invention by the device described by the distinguishing features in the characterizing portion of claim 10.

The inventive method and/or the inventive device enable a reactor in a gas-generating system to be started very rapidly in the case of a cold start and a very uniform distribution and evaporation of the educts, which are to be reacted or reformed, or of at least a portion of the educts, which are to be reformed, to be realized before the latter reach the actual reactor

Due to the possibility of continuously increasing at least one of the educts, for example, for the reforming, with an increasingly rising temperature of the reactor, through which at least a portion of the waste gases is flowing, the temperature of the reactor can be controlled in a particularly advantageous manner and, with that, the danger of overheating a catalyst or the like in the reactor can largely be avoided. In addition, the educts, which are introduced into the hot waste gas stream, are distributed very well in the latter and are evaporated at least already partly already before they reach the actual reactor. With that, a very rapid starting up of the reactor can be attained by a very uniform and homogeneous loading with already evaporated or heated educt.

For the special application case of the gas-generating installation for a fuel cell, especially in the mobile area, this means that, in the case of a cold start, it is possible to start up very quickly and hydrogen is made available very rapidly for operating the fuel cell.

As educt, which is to be metered into the hot waste gas, all hydrocarbons, which are suitable for reforming, can of course be used. It is also conceivable here to operate the installation, with a pre-mix, for example, consisting of methanol and water.

The fuel for producing the thermal energy can be the fuel, which is available anyhow for reforming. However, the use of an appropriate, additional fuel, such as natural gas, naphtha, dimethyl ether, gasoline, liquefied gas or the like is also conceivable. During the starting phase of the gas-generating system, there are decisive advantages here. The appropriately usable fuels may, for example, be easier to evaporate and, with that, permit the gas-generating system to be started at a significantly lower activation energy. In addition, such fuels can be reacted approximately without a residue by means of an appropriate thermal or catalytic conversion. As a result and also because of the rapid heating, the gas-generating system can be operated with a correspondingly low starting emission.

Further advantageous developments of the invention arise out of the remaining dependent claims and from the example, which is illustrated diagrammatically below by means of the drawing, in which

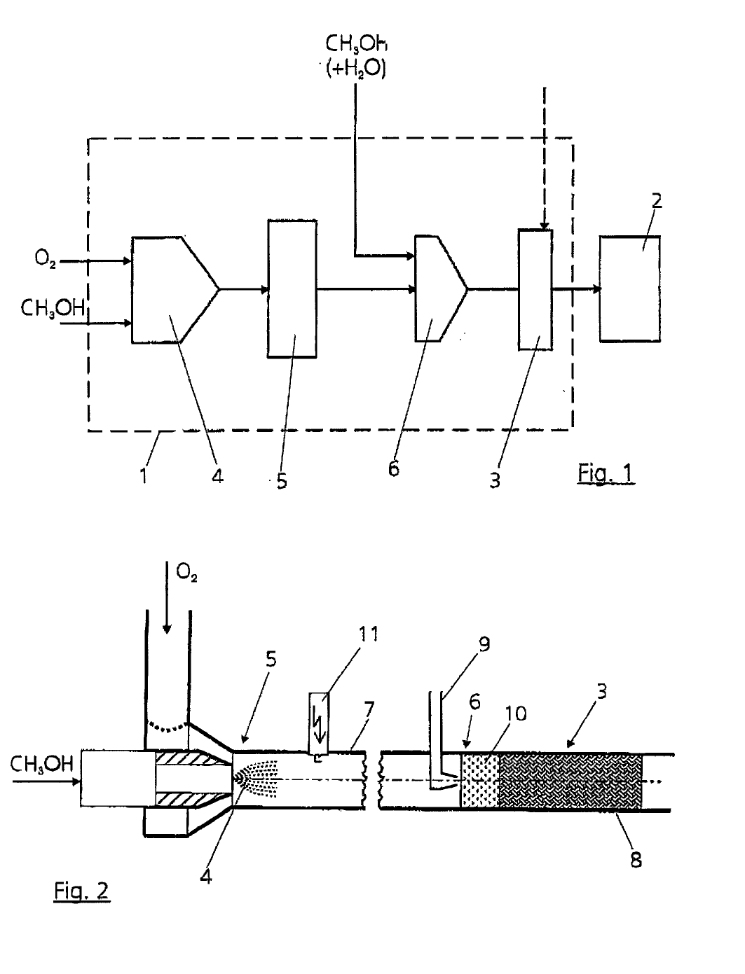

FIG. 1 shows a diagrammatically indicated construction of the gas-generating system with components for carrying out the starting method and

FIG. 2 shows the diagrammatical construction of a burner integrated in the feed pipe of a reformer.

In FIG. 1, a gas-generating system 1 for supplying a fuel cell 2 with a hydrogen-containing gas is indicated highly diagrammatically. The actual generation of the hydrogen-containing gas from, for example, a liquid hydrocarbon, such as methanol (CH₃OH), takes place in a reactor 3, which may be constructed as an autothermal reformer, as a partial oxidation step, as a combination thereof or as a structure comparable thereto.

It is generally known that such reactors 3 require a particular operating temperature, in order to react the educts supplied. In the example shown, these educts are a hydrocarbon, such as the already mentioned methanol (CH₃OH), as well as water, which is reacted in the reactor 3 largely into hydrogen and carbon dioxide. These gases then reach the fuel cell 2, in which the hydrogen is used in the known manner to generate electric energy.

For heating such a reactor 3 in the gas-generating system 1 in the case of a cold start, that is, when the reactor 3 is at a temperature, which is far below the operating temperature of the gas-generating system 1, a hydrocarbon is reacted or combusted, in order to supply the thermal energy for cold starting the reactor 3 in the gas-generating system 1.

In the example shown in FIG. 1, methanol (CH₃OH) and an oxygen-containing gas (O₂), for which air is particularly suitable, are mixed in a mixing region 4 and supplied to a burner 5. The burner 5 may be a conventional flame burner or also a catalytic burner. The waste gases of the burner pass through a further mixing region 6, which will be described in greater detail later on, and reach the reactor 3, heating it with their thermal energy.

In the starting phase of the gas generating system 1, as much hot waste gas as possible is passed as quickly as possible into the reactor 3, in order to heat the latter as quickly as possible to the operating temperature. At the same time, however, the temperature must be monitored so that the catalyst, which is usually present in the reactor 3 will not be damaged by being overheated.

Temperatures of more than 1000° C. usually exist during the combustion in the burner 5. For this reason, one of the educts for the reactor 3, which is to be reformed, is brought in the further mixing region 6 into the hot waste gas flowing to the burner 5. This educt is, in particular, the hydrocarbon, which is to be reformed, that is, methanol. Basically, it is, however, also conceivable to bring in a pre-mix of methanol and water over the mixing region 6 into the hot exhaust gases flowing to the burner 5.

In the mixing region 6, as well as, in a particularly advantageous embodiment, also in the mixing region 4, in each case a static mixer is disposed, which ensures, through pressure losses, turbulences and the like, that the materials introduced are mixed well with one another. In particular, in the mixing region 6, the educts, which are introduced here in liquid form, are mixed with the hot, flowing waste gases, in which they are to be distributed uniformly, and evaporated at least partly.

With that, it can be ensured that the educts, which are to be reformed, are supplied to the reactor 3 in at least a partly evaporated, very uniformly distributed form together with the hot waste gases, so that the reforming of the educts can start very quickly, easily and, with regard to the starting emissions, very cleanly.

In addition, the temperature in the reactor 3 or in the gases flowing into the reactor 3 can be controlled by the educts supplied so that the reactor 3 is not overheated.

This means that, after the starting phase with a rising temperature in the reactor 3, the volume of educts flowing into the mixing region 6 is increased continuously, in order to be able to start up the generation of the hydrogen-containing gas very rapidly and very uniformly.

With respect to the expense of keeping a supply of hydrocarbons, the operating case, shown in FIG. 1, is very advantageous, since only one hydrocarbon (methanol) is used here. Basically, however, it is also conceivable to use a hydrocarbon, which differs from the hydrocarbon added for reforming in the mixing region 6, for operating the burner 5.

In principal, there are several possibilities for running this cold-starting method for the reactor 3 in the gas-generating system 1. The hydrocarbon, supplied in the mixing region 6 can be used for the further heating of the downstream reactor 3. This means that the hydrocarbon, supplied to the mixing region 6, is oxidized practically completely in the region of the reactor. On the other hand, the hydrocarbon can also be used for the standard operation of the reactor, that is, for generating hydrogen by an autothermal reforming.

Basically, the burner 5, which is constructed either as a flame burner or as a catalytic burner, can be operated with different settings of the air lambda or the burner lambda. For example, if the reactor 3 is an oxygen-sensitive reactor, the gas-generating system 1 is started with a lambda of burner 5, which is less than 1 (λ<1) and preferably of the order of 0.5 to 1. As soon as the reactor 3, which is downstream from the burner 5, has reached the operating temperature, the lambda of the burner is increased to a value >1. The supply of fuel to the mixing region 6 is increased correspondingly. Now, however, the fuel can be evaporated in the burner 5 or in the mixing region 4 itself. Therefore, by starting with an appropriate value for lambda of less than 1, reducing conditions are produced in the waste gas of the burner 5, so that a catalyst, present in the reactor 3, cannot be oxidized.

On the other hand, if a reactor 3 is used, which basically is not sensitive to oxygen and therefore does not contain a catalyst or the like, which is oxidized in the presence of a corresponding excess of air, it is possible to start with a lambda value which is less than 1, greater than 1 or also very much greater than 1. By these means, the quality of the waste gases can be affected, since it is well known that the formation of carbon monoxide is reduced by flame burners 5, which are operated with an appropriate excess of air.

FIG. 2 shows a possible construction of the combination of burner 5, mixing region 6 and reactor 3, in which the appropriate elements are integrated with a catalyst 8 in any pipeline 7, which supplies the reactor 3. The educts are supplied here partly over a pipeline 9, which is disposed in the mixing region 6, which is located a short distance in front of a static mixer 10 in the flow direction of the hot waste gases. The burner 5, which is a flame burner 5 here, and in which a mixture of fuel and air can be ignited over an ignition device 11, which is, for example, a spark plug here, is disposed in the feed pipe 7 ahead of the mixing region 6 in the direction of flow.

By integrating the elements in the feed pipe 7, a very space-saving unit of a burner 5 and a reactor 3 with the corresponding mixing regions is 4 and 6 can be constructed. This, in turn, has very advantageous effects on the space required by the gas generating system 1 as a whole and by the fuel cell installation.

What is claimed is:

1. A method for starting a reactor, particularly a reformer, in a gas-generating system of a fuel cell installation at a temperature, which is far below the operating temperature of the gas generating system, a hydrocarbon being reacted for generating thermal energy for heating the reactor and at least a portion of the waste gases of the reacted hydrocarbon flowing into the reactor, wherein, as the reactor temperature increases, an increasing flow of at least one educt (CH₃OH), which is to be reacted in the reactor (3), is introduced and evaporated at least partly in the at least one portion of the waste gases, which flows into the reactor (3).

2. The method of claim 1, wherein the portion of waste gases and the at least one educt (CH₃OH) are brought into an autothermal reformer as at least one part of the reactor (3).

3. The method of claims 1 or 2, wherein the portion of the waste gases and the at least one educt are introduced in a partial oxidation step as at least one part of the reactor (3).

4. The method of claims 1, 2 or 3, wherein the hydrocarbon (CH₃OH) is combusted at least partly in a flame burner (5).

5. The method of one of the claims 1 to 4, wherein the hydrocarbon (CH₃OH) is reacted at least partly in a catalytic reaction.

6. The method of one of the claims 1 to 5, wherein at least a portion of the at least one educt (CH₃OH) is the same hydrocarbon (CH₃OH), which is used during the reaction.

7. The method of one of the claims 1 to 6, wherein water (H₂O) is used as at least one portion of the at least one educt.

8. The method of one of the claims 1 to 7, wherein, after the operating temperature of the reactor (3) is reached, the combustion is carried out with a lambda value of the burner (5), which is larger than 1.

9. The method of one of the claims 1 to 8, wherein, if the reactor (3), is sensitive to oxygen, the reaction is carried out with a lambda value of the burner (5), which is smaller than 1.

10. An apparatus for starting a reactor, particularly a reformer, in a gas-generating system of a fuel cell installation at a temperature, which is far below the operating temperature of the gas-generating system, with at least one burner, which is disposed in front of the reactor in the direction of flow of its waste gases, a mixing region for an oxygen-containing gas and a fuel being disposed ahead of the burner in the flow direction, wherein, after the burner (5) and before the reactor (3) in the flow direction, at least one through the mixing region (6) for the waste gases of the burner (5) and at least one educt (CH₃OH) is disposed, the burner (5) and the further mixing region (6) being integrated in a feed pipe (7) for the reactor (3).

11. The apparatus of claim 10, wherein at least one of the mixing regions (4, 6) has a static mixer (10).

12. The apparatus of claims 10 or 11, wherein the burner (5) is constructed as a flame burner.

13. The apparatus of claim 12, wherein the burner (5) has an ignition device (11).

14. The apparatus of claims 10 or 11, wherein the burner (5) is constructed as a catalytic burner.
